(19) United States
(12) Patent Application Publication
(10) Pub. No.: US 2003/0118203 A1
(43) Pub. Date: Jun. 26, 2003

(54) Layered microphone structure

(76) Inventor: George Raicevich, Chatswood (AU)

Correspondence Address: LADAS & PARRY, 224 SOUTH MICHIGAN AVENUE, SUITE 1200, CHICAGO, IL, 60604, US

(21) Appl. No.: 10/220,839

(22) PCT Filed: Mar. 7, 2001
(86) PCT No.: PCT/AU01/00240

(30) Foreign Application Priority Data
Mar. 7, 2000 (AU) PQ 9510

(51) Int. Cl. H04R 25/00; H02B 1/00; H01H 1/00; H02H 1/00; H01G 2/00; H05F 3/00; H04R 9/08; H04R 11/04; H04R 17/02; H04R 19/04; H04R 21/02

(52) U.S. Cl. 381/174; 381/355; 361/225

(57) ABSTRACT

A capacitive microphone for generating an output signal which is a function of a capacitance between a moveable electrode and a fixed electrode separated by at least one layer disposed therebetween, wherein the at least one layer includes at least one spacer layer formed from one or more sheets of material. By selecting an appropriate thickness and shape of the spacer layer, the separation between the first and second electrodes can be accurately controlled. Large area microphones can be made by configuring the spacer layer such that it supports one or more central regions of the movable electrode. In one embodiment, the spacer layer is formed from a sheet of polymer material, such as polyester.

### TECHNICAL FIELD

The present invention relates to variable capacitor microphones and to a method of fabricating the microphones.

### BACKGROUND OF THE INVENTION

A typical capacitive or condenser microphone includes a first electrode formed by a diaphragm and a second electrode formed by a back plate. The diaphragm and back plate are paired together to form a capacitor in which capacitance varies with sound pressure incident on the diaphragm. Miniature microphones used in hearing aids and other applications typically also include an electret material between the electrodes of the capacitor. Such miniaturised microphones are reaching the limits of traditional manufacturing techniques. As the microphone components are reduced in size, it becomes more difficult to maintain the same level of manufacturing precision, resulting in microphones with variability in sensitivity and impedance. Attempts have been made to overcome the difficulties associated with miniaturising traditional microphones by using semiconductor fabrication techniques to make solid state microphones. This technology can potentially increase the manufacturing precision and reduce the manufacturing cost for large volumes, but restricts the choice of transducer component materials to silicon and associated materials. Consequently, the mechanical characteristics are also restricted. For example, silicon diaphragms have a low compliance, resulting in reduced acoustic sensitivity. Such problems have slowed the commercial introduction of a silicon-based microphone.

### SUMMARY OF THE INVENTION

A first aspect of the present invention provides a capacitive microphone for generating an output signal which is a function of a capacitance between a moveable electrode and at least one fixed electrode separated by at least one spacer layer, wherein the at least one spacer layer is shaped to support one or more regions of the moveable electrode, at least one said region being located inwardly of a perimeter of the moveable electrode.

The microphone structure can be manufactured to high tolerances, for example using optical lithography techniques, or by optical machining (controlled removal of the top layer by laser ablation). Furthermore, the separation between the first and second electrodes can be carefully controlled by selecting the appropriate spacer layer thickness and shape.

The two electrodes are preferably configured as a variable parallel-plate capacitor. Acoustic signals are measured by applying a bias voltage to the electrodes and measuring the change in capacitance as the moveable electrode moves. The moveable electrode may be secured to one face of a diaphragm such that to it deflects with the diaphragm, and the fixed electrode may be secured to a back plate. The moveable and fixed electrodes may comprise electrically conductive coatings formed on opposing faces of the diaphragm and back plate, respectively.

The spacer layer may be shaped to provide support to at least a peripheral region of the moveable electrode, while defining at least one “active” region of the moveable electrode radially inward of the peripheral region where there is a gap between the electrodes, allowing the moveable electrode to deflect. For example, the peripheral region may be annular, providing an active region which is circular and enclosed by the peripheral region. The peripheral region may extend to the perimeter of the moveable electrode.

The microphone may detect acoustic signals travelling through the fixed or moveable electrodes. For example, the microphone may detect acoustic signals travelling in a direction which is generally perpendicular to the moveable electrodes. Alternatively, or additionally, the microphone may detect acoustic signals travelling in a direction which is generally parallel to the moveable electrode, through apertures or so-called side vents, in the microphone. The at least one spacer layer may comprise a plurality of spacer layers. The plurality of spacer layers may be stacked one on top of another such that they either partially or completely overlap. Alternatively, the spacer layers may be arranged such that none of the spacers overlap. A side vent for introducing acoustic signals into the microphone may be formed by providing a separation between neighbouring spacer layers. Acoustic signals may be funnelled into such a side vent via a tube or housing. In one example, the spacer layer is in the form of arc-shaped strips arranged end-to-end around the peripheral region of the diaphragm with a separation between oppositely-facing ends of neighbouring strips such that side vents are formed. A microphone with a side vent may alternatively be formed between non-contacting oppositely-facing end portions of a “C”-shaped one-piece spacer layer.

The spacer layer may support a central region, while not supporting the perimeter of the moveable electrode. Alternatively, the spacer may provide support to the peripheral region of the moveable electrode in addition to a central region, while providing a gap between the electrodes over the remainder of the moveable electrode area. It is known that when a moveable electrode area becomes too large, forces on the moveable electrode such as electrostatic forces can cause it to collapse and fail. The spacer layer preferably provides support to the moveable electrode in a way which prevents diaphragm failure. For example, the spacer layer may provide support to areas where deflection of the moveable electrode would be the greatest, such as radially-inward of the peripheral region.

Such a spacer layer allows the acoustic sensitivity of a microphone to be increased by manufacturing the diaphragm from a material, such as a polymer, which has a relatively high mechanical compliance compared to silicon nitride and other silicon derivatives. Although it is known to increase the sensitivity of microphones by using a diaphragm with a high mechanical compliance, the reduced stiffness of such materials conventionally places limits on the area of the diaphragm.

In one example, the spacer layer includes one or more island-like structures which provide support to selected central regions of the moveable electrode and give rise to active regions of the moveable electrode around each island. In another example, the spacer layer includes fingers extending from the peripheral region in a generally radially-inward direction. Areas between fingers give rise to active regions of the moveable electrode. Fingers on opposite sides of the moveable electrode may be interleaved. One or more fingers may extend radially inward from the peripheral region and branch from there into a plurality of further fingers. Combinations of these various types of fingers may also be used. In yet another example, the spacer layer includes one or more strips connecting opposite parts of the peripheral region such that the moveable electrode is divided into two or more isolated active regions, or “cells”. The spacer layer may have a grid-like configuration which divides the moveable electrode into more than two cells. A wide variety of grid-like spacer layer configurations are possible. In a preferred embodiment, the spacer layer comprises a sheet in which a plurality of apertures are formed in the sheet, each aperture defining the shape of a cell IN which the moveable electrode may deflect either independently or in unison with other cells. Each aperture may be circular, triangular, square, rectangular, polygonal or any one of a variety of other shapes. The apertures may be arranged in the spacer layer in a variety of different patterns. For example, the apertures could be aligned in straight or curved rows or distributed radially about a central point. The spacer layer may also comprise a combination of a grid-like structure and one or more finger structures.

It is preferable to use the active area of the moveable electrode since microphone sensitivity is maximised when the active area is maximised. The spacer layer allows the forces on each cell to be reduced to below that which would collapse the moveable electrode. The sensitivity of the microphone can then be raised by increasing the active area without being limited by collapsing forces. Unusually large microphones can be formed by dividing a large moveable electrode into numerous small-area cells. The moveable electrode, or moveable electrode plus diaphragm, can be made from higher compliance materials than would be possible with a microphone having a large but single active area.

The back plate, spacer layer, or diaphragm may be made from one or more polymer sheet materials, such as polyester, and preferably all of these components are made from a polymer mal. A combination of different materials may be used in the microphone. Polymer sheet material has the advantage that it can be cut to high precision using laser cutting techniques. In one particular embodiment, the diaphragm and back plate are formed from sheets of polyester. The moveable and fixed electrodes may comprise conductive gold films coated on faces of the diaphragm and back plate, respectively. The impedance and sensitivity of the microphone can be controlled by changing the shape, size and thickness of the spacer layer.

Vibration of the moveable electrode will be at least partially restricted, and is preferably prevented entirely, wherever the moveable electrode makes contact with the spacer layer. This may be achieved by attaching the moveable electrode directly to the spacer layer, such as with adhesive or fasteners, in order to limit deflection away from the spacer. Alternatively, the moveable electrode may be held down against the spacer layer by a clamping means disposed on an opposite face of the diaphragm to the spacer layer. Preferably, the clamping means only restricts deflection of the moveable electrode over areas which are supported by the spacer layer. Clamping the moveable electrode between the spacer layer and clamping means allows deflection to be confined more effectively to each cell. A plurality of clamped cells thus effectively operate as small vibrationally-isolated moveable electrodes acting in unison. The clamping means may be held in place by an external pressure applied against the clamping means towards the moveable electrode. Additionally, or alternatively, an adhesive may be used to hold the clamping means in place such that deflection of the moveable electrode is restricted.

The clamping means may be a flat sheet with a shape and size very similar to that of the spacer. In one embodiment, the clamping means and spacer layer are both an annulus having an identical shape, and identical internal and external diameters. In another embodiment, the clamping means and spacer layer both have an identical grid-like structure. In a further embodiment, the spacer layer and clamping means both comprise layers in which rows of hexagonal apertures are formed. When the microphone is assembled, the clamping means and spacer layer are positioned such that the hexagonal apertures are aligned.

An omnidirectional microphone may be formed by introducing acoustic signals into the microphone from one face of the moveable electrode only, such as the face of the moveable electrode facing away from the spacer layer. A directional microphone may be formed by introducing acoustic signals into the microphone from both sides of the moveable electrode. Such a microphone may include an acoustic inlet in the back plate and fixed electrode, and/or a side vent formed by a gap or channel in the spacer layer, for the passage of acoustic signals. The microphone may further include an acoustic delay element in communication with the acoustic inlet. An acoustic signal reaching the moveable electrode via the acoustic delay element will be time-delayed with respect to an acoustic signal reaching the opposite side of the moveable electrode. The microphone is thus made sensitive to the spatial direction-of-arrival of acoustic signals. As the time delay of the acoustic delay element approaches infinity, the microphone becomes an omnidirectional device. In embodiments in which the moveable electrode is divided into a plurality of cells, the back plate and fixed electrode preferably includes a separate acoustic inlet beneath each cell. The acoustic delay element may communicate with the plurality of cells via the plurality of acoustic inlets.

Known acoustic delay elements may be used with the microphone. Preferably, the acoustic delay element is formed by the combination of an acoustic resistance element in conjunction with a rear chamber (also known as cavity) that forms an acoustic compliance. The resistance and the compliance act to create a tie delay. The rear chamber communicates with each respective diaphragm cell via each respective acoustic inlet in the back plate and fixed electrode. The chamber may terminate with a rear plate which has an acoustic resistance formed by a porous passage. Alternatively, the rear plate may be sealed off and not have a porous passage. In this case, the rear port effectively creates an infinite delay, resulting in an omnidirectional microphone.

The sensitivity of any one of the above microphones may be enhanced further by including a second fixed electrode on an opposite side of the moveable electrode to the first-mentioned fixed electrode. The moveable electrode is thus disposed between two fixed electrodes, effectively forming two capacitors in parallel. If the moveable electrode moves towards the first fixed electrode, the first capacitance will increase while the second capacitance will decrease, and vice verse. The first and second capacitances are preferably combined together to maximise the output signal, and thus also the sensitivity of the microphone. The second fixed electrode may be secured to a “front plate”. Preferably, the second fixed electrode comprises a conductive coating formed on the front plate, and the moveable electrode comprises conductive coatings formed on opposite faces of a diaphragm preferably with an electrical connection between the two coatings. Diaphragm deflection can then be detected from a second capacitance (between the second fixed electrode and moveable electrode) in addition to the first-mentioned capacitance. The second fixed electrode may be separated from the moveable electrode by a second spacer layer identical to any one of the spacer layers described above. Preferably, the second spacer layer between the second electrode and moveable electrode is aligned with an identically-shaped first spacer layer between the moveable electrode and first electrode. It is preferable that the first and second spacers substantially overlap. A clamping means may be provided to hold the front plate in place.

Any one of the above microphones may be constructed as either a purely capacitive microphone, or optionally, as a capacitive microphone with an electret layer between each pair of fixed and moveable electrodes to create a baseline electric field, The baseline electric field can be enhanced with an externally-applied electric field. The electret is preferably attached to a fixed electrode in order to avoid reducing the compliance of the diaphragm.

A second aspect of the present invention provides a stacked microphone formed from a plurality of sub-microphones, each sub-microphone being in accordance with any one of the microphones described above, wherein the sub-microphones are stacked one on top of the other such that all moveable and fixed electrodes are substantially parallel. The second aspect allows the microphone sensitivity to be increased by stacking sub-microphones such that the first fixed electrode of a first subs microphone also functions as a fixed electrode of a second sub-microphone. Each stacked microphone may have a front plate and/or a back plate at opposite ends. Acoustic signals may be introduced through side vents formed by one or more spacer layers as described above.

A third aspect of the invention provides a method of separating a fixed electrode from a moveable electrode in a capacitive microphone, the method comprising a step of mounting at least one layer between the fixed electrode and moveable electrode, the at least one layer including a spacer layer formed from one or more sheets of material. The at least one spacer layer may be in accordance with any one of the spacer layers described above.

The components of any one of the embodiments described above can be manufactured from a variety of materials using a variety of different techniques. For example, the spacer layer, back plate, front plate, and clamping means can be made from silicon or associated materials using known lithography and etching techniques. Alternatively, laser patterned ablation of multiple layers may be used to form the diaphragm, spacer layer, back plate, front plate, and clamping means from sheets of material. Many layers can be machined simultaneously (bulk machining) in this way using light masks with multiple patterns of the same part.

Accordingly, a fourth aspect of the invention provides a method of fabricating components of a capacitive microphone formed from layers comprising a back plate, a diaphragm, and a spacer layer for separating the back plate from the diaphragm, and a clamping layer for clamping the diaphragm against the spacer layer the method comprising the steps of:

(a) providing a pattern for the layers,

(b) transferring the pattern for each layer onto at least one lithographic mask; and

(c) passing laser light through each lithographic mask such that unmasked light removes unwanted material from each layer.

The capacitive microphone may be in accordance with any one of the embodiments described above. In an embodiment of this method, the pattern for each layer is transferred onto a chrome-on-quartz lithographic mask using electron beam lithography. The laser light typically has a wavelength of 193 nm light and is produced by an excimer laser. A number of layers may be formed simultaneously in this way (i.e. “bulk machining”), which lowers the production cost of a microphone.

The diaphragm, spacer layer, back plate, front plate, and clamping means may also be manufactured using the “LIGA” process, or a LIGA-like process. LIGA is a three-stage process which can be used for the manufacture of high aspect ratio. 3-D microstructures in a wide variety of materials (e.g. metals, polymers, ceramics and glasses). The name is derived from the German acronym Lithographie, Galvanoformung, und Abformung, i.e. lithography, electroplating and moulding.

The diaphragm, spacer layer, back plate, front plate, and clamping means may also be mechanically stamped out using a process similar to that used to form compact discs. All of these techniques have the advantage that the components can be manufactured to a high tolerance, such as to within microns or sub-microns while allowing simultaneous production of many parts. Any one of a variety of known cutting or forming techniques may be used to shape the layers in the microphone.

A fifth aspect of the invention provides a method of fabricating components of a capacitive microphone formed from layers comprising a back plate, a diaphragm and a spacer layer for separating the back plate from the diaphragm, and a clamping layer for clamping the diaphragm bracket to the spacer layer, the method comprising the steps of:

providing a pattern for each of the layers;

transferring the pattern onto each of the layers using a laser beam.

The step of transferring the pattern onto each layer using a laser beam may involve relative movement of the laser with respect to each layer, such as by direct-writing with a laser beam onto the layer.

Throughout this specification, unless the context requires otherwise, the word “comprise” or variations such as “comprises” or “conprisingc”, will be understood to imply the inclusion of a stated element or integer or group of elements or integers but not the exclusion of any other element or integer or group of elements or integers.

In order that the present invention may be more clearly understood, embodiments of the invention will now be described, by way of example, with reference to the accompanying drawings.

### BRIEF DESCRIPTION OF THE DRAWINGS

FIG. 1 shows a top view of a first embodiment of a microphone.

FIG. 2 shows an exploded cross-sectional view through section I-I of FIG. 1

FIG. 3 shows plan views of each of the microphone layers shown in FIG. 2.

FIG. 4 shows a top view of a second embodiment of a microphone.

FIG. 5 shows an exploded cross-sectional view through section II-II of FIG. 4,

FIG. 6 shows plan views of each of the microphone layers shown in FIG. 5.

FIG. 7 shows plan views of seven alternative embodiments of spacer layers.

FIG. 8 shows a top view of a third embodiment of a microphone.

FIG. 9 shows an exploded cross-sectional view through section III-III of FIG. 8.

FIG. 10 shows a top view of a fourth embodiment of a microphone.

FIG. 11 shows an exploded cross-sectional view through section IV-IV of FIG. 10.

FIG. 12 shows an exploded cross-sectional view of a fifth embodiment of a microphone.

FIG. 13 shows a plan view of a C-shaped spacer layer shown in FIG. 12.

FIG. 14 shows an exploded cross-sectional view of a sixth embodiment of a microphone.

FIG. 15 shows an exploded cross-sectional view of a seventh embodiment of a microphone.

FIG. 16 shows an exploded cross-sectional view of an eighth embodiment of a microphone as seen though section V-V of FIG. 17.

FIG. 17 shows a pictorial view of a spacer layer with channels shown in FIG. 16.

### DETAILED DESCRIPTION OF THE DRAWINGS

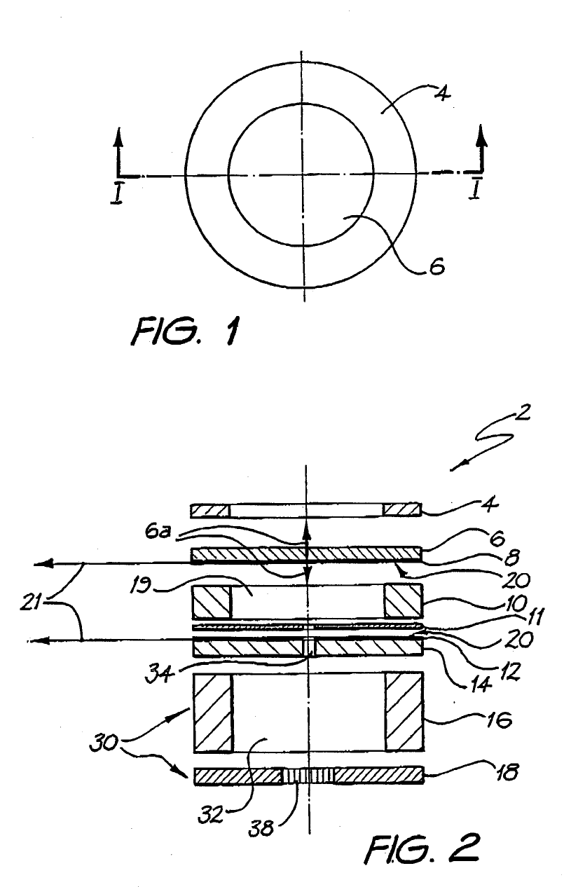

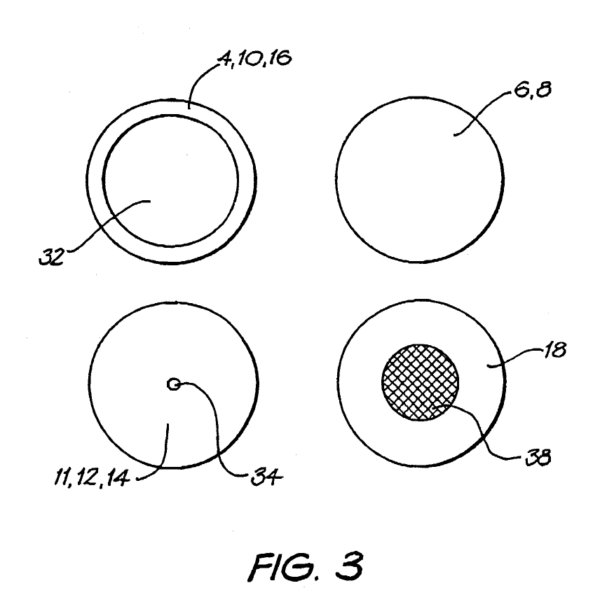

A first embodiment of a microphone 2 will now be described with reference to FIGS. 1 to 3. The microphone is composed of successive parallel layers, namely a clamping layer 4, an elastically resilient diaphragm 6, a moveable electrode 8 attached to one side of the diaphragm 6, a spacer layer 10, an electret layer 11, a fixed electrode 12 attached to a back plate 14, rear cavity walls 16, and a rear plate 18. Plan views of each of the layers are shown in FIG. 3. The clamping layer 4 and spacer layer 10 are both sheets of material which have been cut into the shape of an annulus sized to support the periphery of the diaphragm 6. The clamping layer 4 is also attached to the diaphragm 6 with an adhesive. The spacer layer forms a thin cavity 19 between the moveable and fixed electrodes. The electrodes 8, 12 are formed by coating two faces 20 of the diaphragm 6 and back plate 14, respectively, with a conductive material. An acoustic signal incident on the diaphragm 6 causes diaphragm deflection, as indicated by arrows 6a, which in turn causes a change in capacitance between electrodes 8, 12. The electret layer 11 creates an electric field between the two electrodes 8, 12, and is bonded to the back plate 14. The electret in this embodiment is formed from amorphous teflon, but it will be understood that alternative electret materials may be substituted. The conductive material is a 100 nanometre vacuum-deposited gold film. However, it is understood that conductive coatings can be made from a variety of other known materials, including aluminium, titanium, chromium, copper, or conductive oxides such as indium tin oxide (“ITO”). Alternatively, if the diaphragm and back plate are themselves formed from conductive materials, conductive coatings are not required. Microphone output is measured via electrical leads 21 connected to the electrodes 8, 12. When the microphone 2 is assembled, two electrodes 8, 12 are separated by the spacer layer 10. The diaphragm 6 is clamped together with the moveable electrode 6 against the spacer layer by the clamping layer 4. The clamping layer 4, diaphragm 6, spacer layer 10, and back plate 14 may all be cut out of sheet material. In this embodiment, the sheet material is polyester, but it will be appreciated by those skilled in the art that many other types of sheet material may also be suitable, including polycarbonate, silicon, silicon nitride, and silicon dioxide.

Am acoustic delay element 30 is attached to the back plate 14. The acoustic delay element 30 comprises a chamber 32 formed between cylindrical walls 16 extending downwardly from the back plate 14, and a porous passage 38 in the rear plate 18. The porous passage 38 functions as an acoustic resistive element. The chamber 32 is in communication with the cavity 19 beneath the diaphragm via an inlet 34 in tile back plate 14 and fixed electrode 12, and effectively time-delays acoustic signals travelling to the diaphragm 6 via the back plate 14.

In a particular example, typical dimensions of the microphone are as follows:

active electrode surface area: 2 mm²;

diaphragm layer thickness 6 μm;

spacer layer thickness: 6-20 μm;

electret (teflon) layer thickness 50 μm;

rear cavity height: 1 mm;

electrode layer thickness 100 nm

These dimensions are intended as an example only, and the microphone may be made larger or smaller than this example, depending on requirements. It will be understood by a person skilled in the art that dimensions of at least some of the microphone components will have limits on size. For example, if the diaphragm diameter made too large the electrostatic forces acting on it will force it to collapse onto the back plate. An advantage of this particular embodiment is that the active microphone diaphragm area is divided into smaller, independently-supported cells. The effective microphone surface area, and hence acoustic sensitivity, can be increased without concern for diaphragm collapse compared to a single cell diaphragm of equivalent active area.

Any one of a variety of known cutting or forming techniques may be used to shape the layers in the microphone. For example, the clamping layer 4, diaphragm 6, spacer layer 10, back plate 14, and rear plate 18 could each be cut by a laser or mechanically stamped out. The process of cutting out any one of these layers using a laser involves the following steps. A sheet of suitable material, for example polyester, with the appropriate thickness for one or more of the layers of the microphone is placed on a moveable table. The table can be moved in two horizontal directions (X, and Y) relative to a laser positioned above the material to be cut. The movement of the table is controlled by a Computer Numerical Control (CNC) program. The CNC program controls the positioning of the table and light fluence from the laser. Using the CNC each layer of the microphone can be cut to any two-dimensional pattern. Each layer can be further patterned in the vertical dimension (Z) by limiting the laser radiation fluence, A LIGA or LIGA-like process, or a process akin to the known process of stamping CDs could also be used to form any one of the layers.

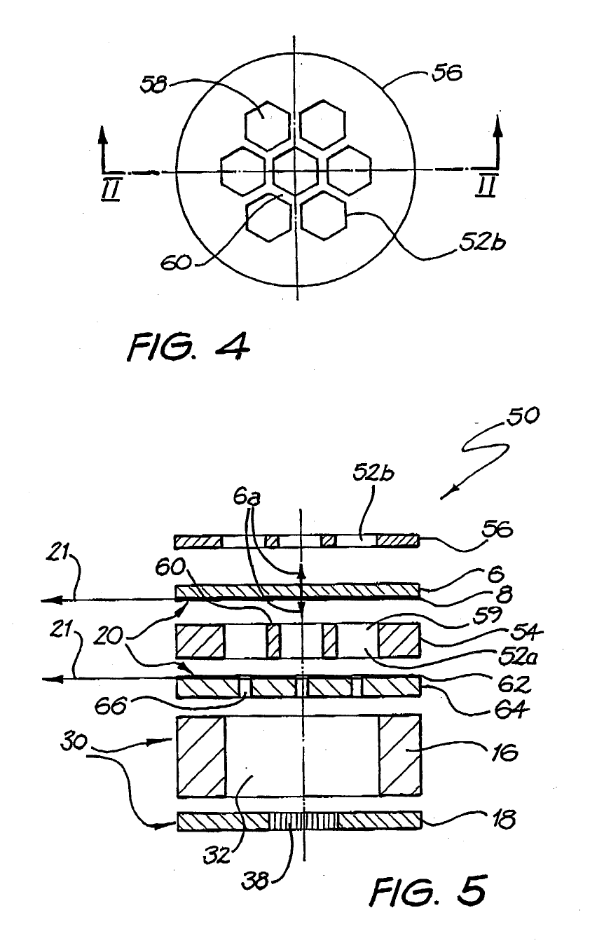

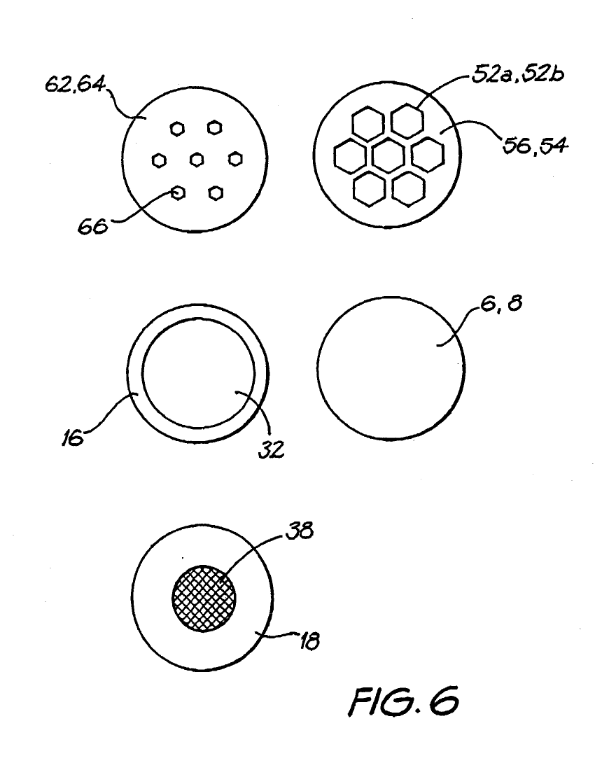

A second embodiment of the microphone 50 will now be described with reference to FIGS. 4, 5 and 6. The same reference numerals will be used where the features are the same as in the previous embodiment. The microphone again consists of successive parallel layers but differs in that seven hexagonal apertures 52a are formed in the spacer layer 54, and seven hexagonal apertures 52b are formed in the clamping layer 56 to define seven hexagonal active regions 58 of the diaphragm 6, referred to as cells, between support portions 60 which support central regions of the diaphragm A cavity 59 is provided beneath each cell 58 to enable diaphragm deflection to take place in the cell 58. Plan views of each of the microphone layers are shown in FIG. 6. An electret layer is not shown in this embodiment, but it is understood that an electret layer could be sandwiched between the spacer layer 54 and fixed electrode 62 as with the first embodiment. Such an electret would have the same plan view pattern as the fixed electrode 62 and back plate 64 shown in FIG. 6. The hexagonal apertures 52a in the clamping layer 56 are identical to, and aligned above, the apertures 52b in the spacer layer 54. The microphone also includes an acoustic delay element 30 which is identical to the acoustic delay element 30 described above with respect to FIG. 2. The chamber 32 is in communication with each of the diaphragm cavities 59 by a plurality of acoustic inlets 66 in the back plate 64 and fixed electrode 62, each inlet 66 being located beneath a diaphragm cell 58 and cavity 59.

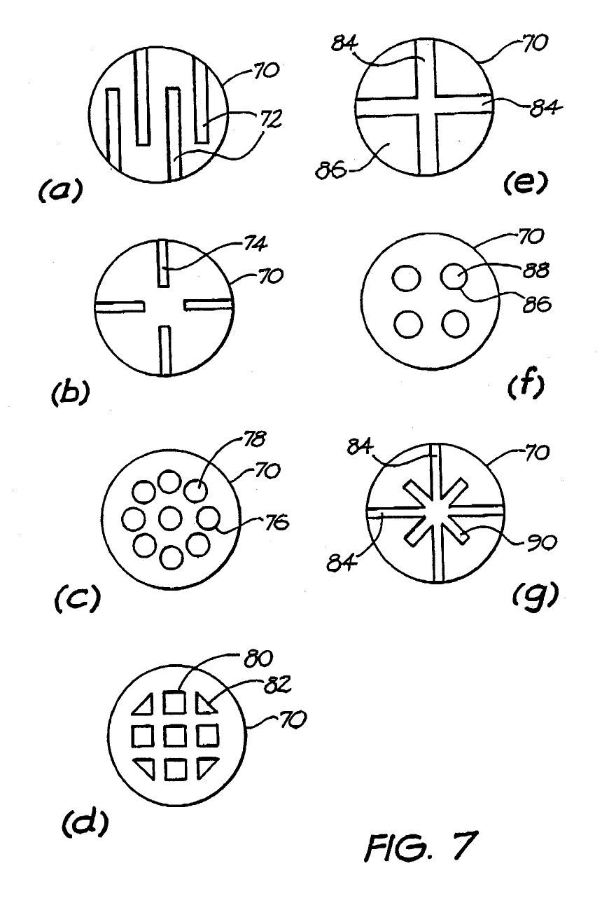

FIG. 7 shows further examples of flat sheets 70 which could be used as either a clamping layer or a spacer layer in any of the embodiments described above or below. It can be seen that the two dimensional configuration of the spacer/clamping layer can be varied in many different ways. The examples shown in FIG. 7 are: (a) interleaved fingers 72; (b) inwardly-directed radial fingers 74; (c) concentrically-distributed circular apertures 76 for defining nine circular cells 78 in a diaphragm; (d) a combination of square apertures 80 and triangular apertures 82; (e) two crossed strips 84 for defining four quarter-circle cells 86 in a diaphragm; (f) four circular apertures 86 for defining four circular cells 88 in a diaphragm; and (g) two crossed strips 84 with four fingers 90 which branch out from the centre.

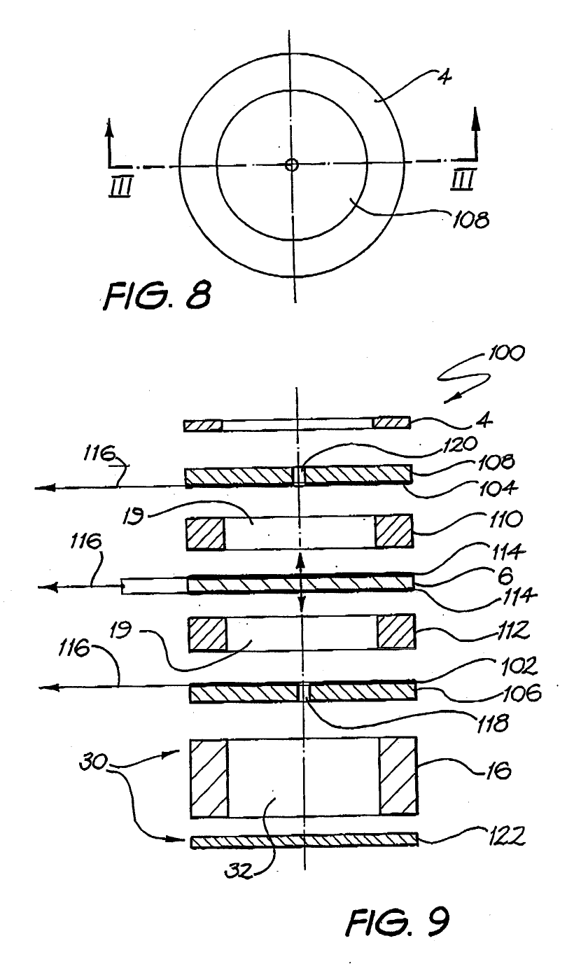

A third embodiment of the microphone 100 will now be described with reference to FIGS. 8 and 9. The same reference numerals will be used where the features are the same as in the previous embodiments. This embodiment includes a first fixed electrode 102 and a second fixed electrode 104 on opposite sides of a diaphragm 6. The first and second fixed electrodes 102, 104 are attached to a back plate 106 and a front plate 108, respectively, such that both electrodes face the diaphragm 6. The 5 diaphragm 6 is separated from the first fixed electrode 102 by a fast spacer layer 112, and from the second fixed electrode 104 by a second spacer layer 110. Both sides of the diaphragm are coated with a conductive material to form a pair of parallel moveable electrodes 114 which are electrically connected together. However, it will be understood that there may be situations in which it is preferable to electrically isolate the two moveable electrodes 114. The first and second fixed electrodes 102, 104 comprise electrically conductive coatings formed on the back plate 106 and front plate 106, respectively. Any one of the conductive coatings described in the first embodiment, such as a 100 nanometre gold film, can be used to form the fixed and moveable electrodes 102, 104, 114. The microphone 100 effectively forms two capacitors, the first capacitor consisting of the first fixed electrode 102 in conjunction with the moveable electrode 114, and the second capacitor being formed by the second fixed electrode 104 in conjunction with the moveable electrode 114. Electrical leads 116 attached to each of the electrodes enable electrical output of the microphone to be measured. A first acoustic inlet 118 is formed through the back plate 106 and first fixed electrode 102, and a second acoustic inlet 120 is formed through the front plate 108 and second fixed electrode 104. The rear plate 122 in this embodiment is a solid plate without a porous section, creating a very high infinite acoustic resistance. Each of the layers of this microphone can be made in the same way as the equivalent layers described in the fist embodiment.

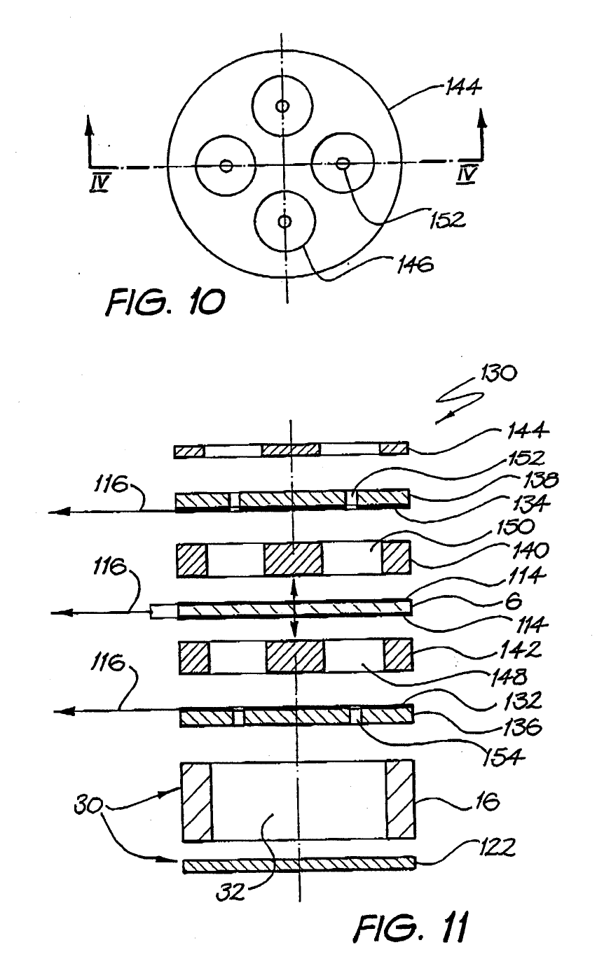

A fourth embodiment of the microphone 130 is shown in FIGS. 10 and 11. As with the third embodiment, this microphone includes a first fixed electrode 132 and a second fixed electrode 134 on opposite sides of a diaphragm 6. The first and second fixed electrodes 132, 134 are attached to a back plate 136 and a front plate 138, respectively, such that both electrodes 132, 134 face the diaphragm 6. However. Mike the third embodiment, this microphone is configured as a “multi-cell” microphone, that is, the first spacer layer 142, second spacer layer 140 and clamping layer 144 divide the diaphragm 6 into a plurality of cells. In this case, each spacer and clamping layer 140, 142, 144 includes four circular apertures 146 arranged in the same spacer layer pattern 70 which is shown in FIG. 7(f), and therefor defines four circular cells. The first and second spacer layers also define a cylindrical cavity 148, 150 on opposite sides of each diaphragm cell. Acoustic signals enter the microphone 130 via four front acoustic inlets 152 in the front plate 138 and the second fixed electrode 134. Each front acoustic inlet 152 is aligned with the centre of a cavity 150. The chamber 32 of the acoustic delay element 30 is in communication with four respective diaphragm cavities 148 (formed by the back spacer layer 142) via four respective acoustic inlets 154 in the back plate 136 and first fixed electrode 132, each inlet 154 being located beneath a cavity 148.

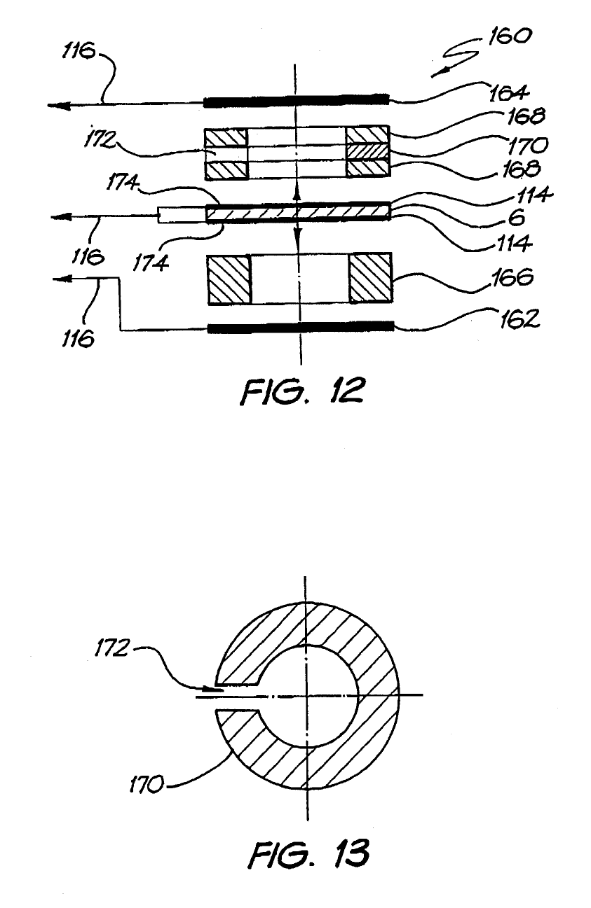

A fifth embodiment of the microphone 160 is shown in FIGS. 12 and 13. As with the third and fourth embodiments, this microphone is equivalent to two parallel-plate capacitors connected in parallel. The microphone 160 includes a diaphragm 6 with 100 nanometre-thick gold film electrodes 114 formed on opposite faces, as well as a first fixed electrode 162 and a second fixed electrode 164. Each fixed electrode 162, 164 is formed from an electrically conductive material which is thick enough and strong enough to be self-supporting and perform the dual functions of an electrode and a front plate or back plate. Thus, this embodiment does not include any font plate or back plate. It will be understood that such self-supporting electrodes 162, 164 may be used in any of the other embodiments described herein as an alternative to a conductive coating formed on a front plate or back plate. The diaphragm 6 is separated from the first fixed electrode 162 by an annular first spacer layer 166, and is separated from the second fixed electrode 164 by a second spacer layer in the form of three component spacer layers 168, 170 stacked one on top of the other. The component spacer layers 168, 170 comprise two annular layers 168 and a C-shaped spacer layer 170 sandwiched therebetween. The C-shaped component layer 170 forms a side vent 172 for receiving acoustic signals, while the annular component spacer layers 168 provide support around the entire peripheral region 174 of the diaphragm 6. If required, the stacked component spacer layers 168, 170 could be used in any of the other microphone embodiments described herein. Unlike embodiments described above, acoustic signals enter his microphone through the side vents 172. Thus, the first and second fixed electrodes 162, 164 do not include any acoustic inlets for the passage of acoustic signals. A pipe or funnel way be attached to the side vent 172 to detect sound from a particular location.

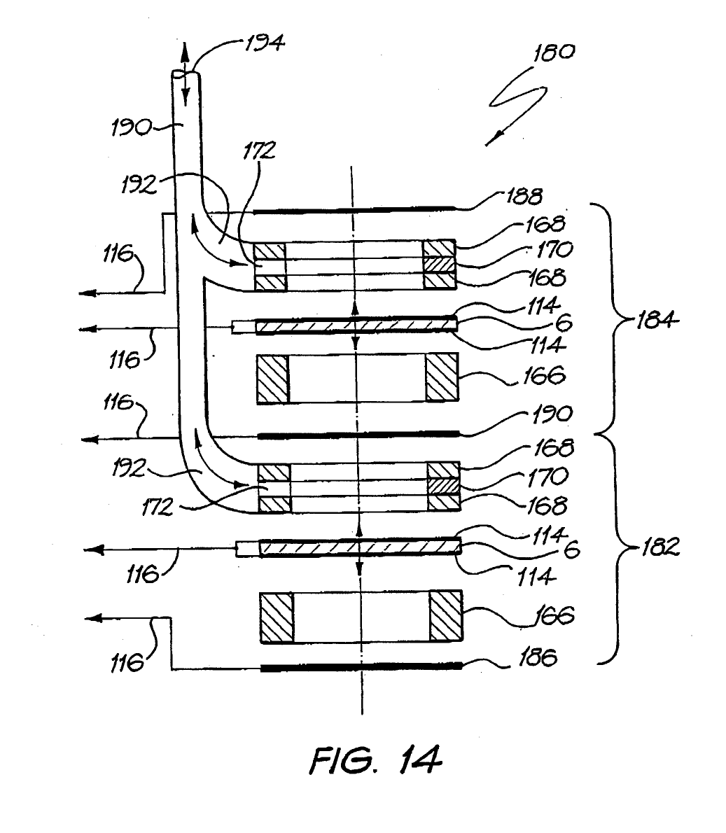

A sixth embodiment of the microphone 180 will now be described with reference to FIG. 14. This microphone 180 is formed by stacking two of the microphones 160 shown in the fifth embodiment (FIG. 12) one on top of the other. The resultant microphone structure is equivalent to four parallel-plate capacitors connected in parallel and provides greater sensitivity than the previous embodiment. The microphone 180 comprises a lower sub-microphone 182 and an upper subs microphone 184. The lower sub-microphone 182 has a first fixed electrode 186, and the upper sub-microphone 184 has a second fixed electrode 188, and both sub-microphones share a centrally-located third fixed electrode 190. All other features of the sub microphones are the same as those shown in FIGS. 12 and 13. As with the fifth embodiment, side vents 172 are formed by C-shaped component spacer layers 170 sandwiched between annular component spacer layers 168. An acoustic inlet tube 190 divides into two branch tubes 192 which feed acoustic signals into the two respective side vents 172. Since acoustic signals may only enter the microphone via a single inlet port 194, the microphone is omnidirectional.

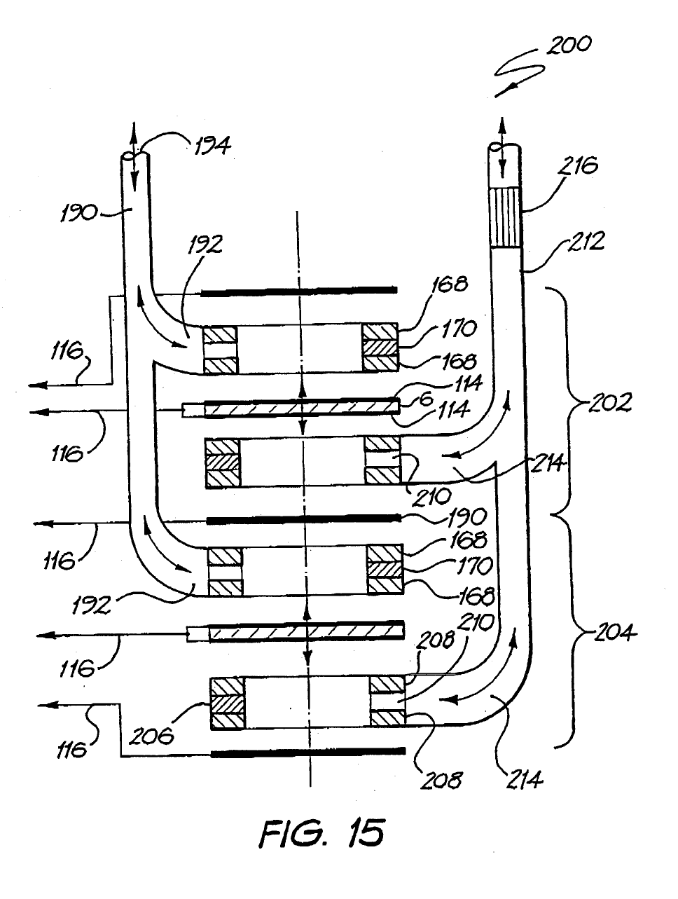

A seventh embodiment of the microphone 200 is shown in FIG. 15 This embodiment is similar to the stacked microphone shown in FIG. 14. Again, the microphone 200 is formed from an upper sub-microphone 202 and a lower sub microphone 204, with each sub-microphone having a first spacer layer 206, 208 and a second spacer layer 168, 170. The second spacer layer 168, 170 of each sub-microphone 204 forms first side vents 172 with a C-shaped component spacer layer 170 sandwiched between two component annular spacer layers 168. This microphone differs from the sixth embodiment in that the first spacer layer 206, 208 of each sub-microphone also comprises a C-shaped component spacer layer 206 sandwiched between two annular second spacer layers 208. Each second C-shaped spacer layer 206 forms a second side vent 210 located on an opposite side of the microphone to the first side vents 172. A second inlet tube 212 divides into two branch tubes 214 for feeding acoustic signals into the second side vents 210. A resistance element 216 is provided in the second inlet tube 212 which together with the cavity enclosed by the spacer introduces an acoustic delay with respect to the first inlet tube 190, and thus make the microphone 200 directional.

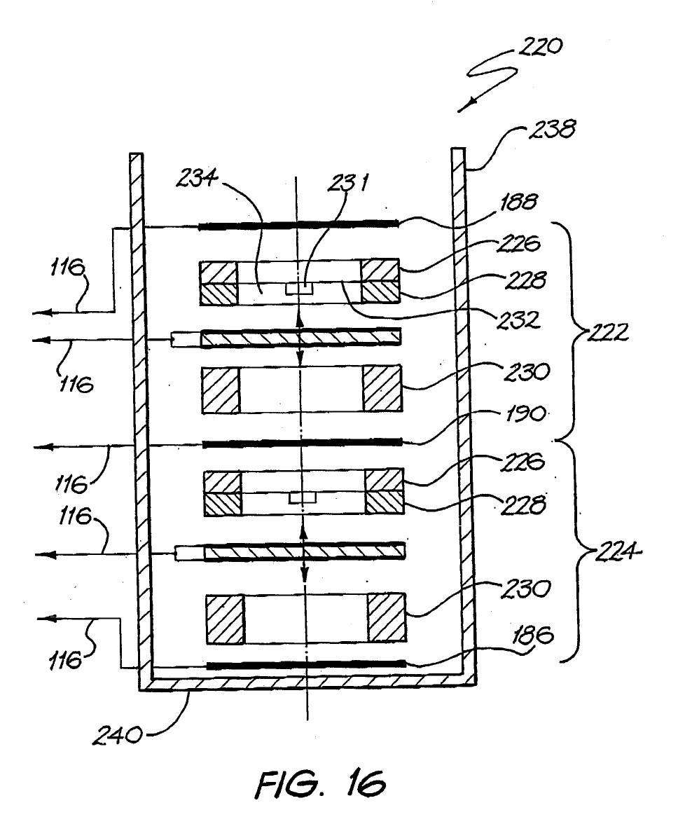

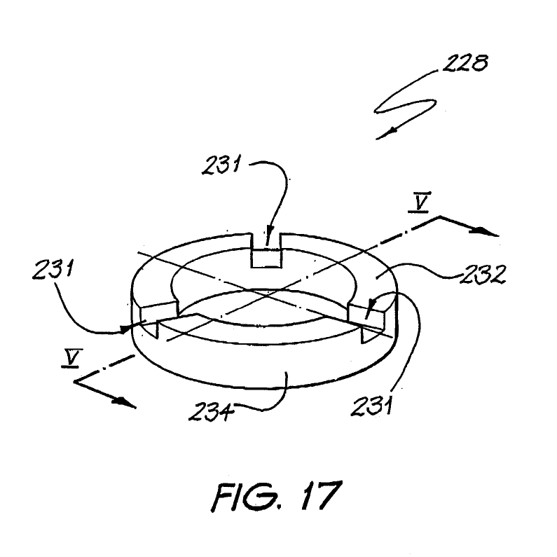

An eighth embodiment of the microphone 220 will now be described with reference to FIGS. 16 and 17. This embodiment also has similarities to the stacked microphone shown in FIG. 14. Again, the microphone 220 is formed from an upper sub-microphone 222 and a lower sub-microphone 224, with each sub-microphone having a first spacer layer 230 and a back spacer layer 226, 228. Each first spacer layer 230 is cylindrical and does not include any side vents. Each second spacer layer 226, 228 comprises a double layer formed by a first annular component layer 226 which is cylindrical, and a second annular component layer 228 which is cylindrical and includes three radial channels 231 in an upper edge 232 of the cylinder walls 234. The first annular component layer 226 is stacked on top of the second annular component layer 228 and forms a bridge over the three channels 231. Each channel 231 in the second annular component layer 228 provides the function of a side vent for receiving acoustic signals. This example of a spacer layer 226, 228 may also be used in any of the other embodiments described herein where one or more side vents are required. It will be understood that the number of channels 231 in the second annular component layer 226 can be varied, depending on the number of side vents required. The entire microphone 220 is disposed within a cylindrical housing 238 which is closed off at one end 240. The housing 238 serves to guide acoustic signals into the microphone via the channels is 230.

The present invention also includes within its scope a spacer layer which provides one or more acoustic inlets (eg. acoustic inlet 34 shown in FIG. 2) in addition to side vents (eg. vent 172 in FIG. 13 or channel 231 in FIG. 17). Such a spacer layer may be combined with any one of the microphone embodiments described above.

It will be appreciated by a person skilled in the art that the numerous variations and/or modifications may be made to the invention as shown in the specific embodiments without departing from the spirit or scope of the invention as broadly described. The present embodiments are therefore to be considered in all respects as illusive and not restrictive.

The claims defining the invention are as follows:

1. A capacitive microphone for generating an output signal which is a function of a capacitance between a moveable electrode and at least one fixed electrode separated by at least one spacer layer, wherein the at least one spacer layer is shaped to support one or more regions of the moveable electrode, at least one said region being located inwardly of a perimeter of the moveable electrode.

2. The microphone according to claim 1, wherein the spacer layer is formed from a polymer material.

3. The microphone according to claim 2, wherein the polymer material is polyester.

4. The microphone according to any one of the preceding claims, wherein the spacer layer is shaped to provide support to the moveable electrode over at least a peripheral region of the moveable electrode, and to provide at least one active region of the moveable electrode located inwardly of the peripheral region in which there is a gap between the moveable and fixed electrodes for deflection of the moveable electrode.

5. The microphone according to any one of the preceding claims, wherein the at least one spacer layer comprises an annulus-shaped spacer layer.

6. The microphone according to any one of the preceding claims, wherein the at least one spacer layer comprises a plurality of spacer layers.

7. The microphone according to any one of the preceding claims, wherein the at least one spacer layer is shaped to provide at least one side vent for facilitating transfer of acoustic signals into and out of the microphone.

8. The microphone according to claim 7, wherein the side vent is defined by a channel formed in the at least one spacer layer.

9. The microphone according to claim 7 or claim 8, wherein the at least one spacer layer comprises a “C”-shaped spacer layer, wherein non-contacting oppositely-facing end portions of the “C”-shaped spacer layer define the side vent.

10. The microphone according to claim 9, wherein the at least one spacer layer further comprises an annulus-shaped spacer layer.

11. The microphone according to claim 9, wherein the “C”-shaped spacer layer is disposed between two annulus-shaped spacer layers.

12. The microphone according to any one of the preceding claims, wherein the spacer layer comprises a plurality of arc-shaped spacer layers which support peripheral regions of the moveable electrode such that there is a gap between neighbouring arc-shaped spacer layers, whereby a plurality of side vents are formed for introducing acoustic signals into the microphone.

13. The microphone according to claim 12, wherein the plurality of arc-shaped spacer layers are disposed between two annulus-shaped spacer layers.

14. The microphone according to any one of the preceding claims, wherein the spacer layer includes at least one separate island-like structure for providing support to the at least one inwardly located region of the moveable electrode.

15. The microphone according to any one of the preceding claims, wherein the spacer layer comprises fingers extending in a generally radially-inward direction from a perimeter of the moveable electrode for providing support to the at least one inwardly located region of the moveable electrode.

16. The microphone according to any one of the preceding claims, wherein the spacer layer is such that it defines a plurality of isolated active regions of the moveable electrode in which there is a gap between the moveable and fixed electrodes for deflection of the moveable electrode.

17. The microphone according to claim 16, wherein the plurality of active regions are defined by a plurality of apertures in the spacer layer.

18. The microphone according to claim 17, wherein the plurality of apertures are arranged in a grid-like configuration.

19. The microphone according to either claim 17 or 18, wherein the apertures are hexagonal.

20. The microphone according to either claim 17 or 18, wherein the plurality of apertures are circular.

21. The microphone according to any one of the preceding claims, wherein the moveable electrode is secured to a face of a diaphragm such that it can deflect with the diaphragm.

22. The microphone according to claim 21, wherein the moveable electrode comprises an electrically-conductive coating.

23. The microphone according to claim 21 or claim 22, wherein the diaphragm is formed from a polymer material.

24. The microphone according to claim 23, wherein the polymer material is polyester.

25. The microphone according to any one of the preceding claims, wherein the fixed electrode is secured to a back plate.

26. The microphone according to claim 25, wherein the fixed electrode comprises an electrically-conductive coating.

27. The microphone according to claim 25 or claim 26, wherein the back plate is formed from a polymer material.

28. The microphone according to claim 27, wherein the polymer material is polyester.

29. The microphone according to any one of the preceding claims, further comprising clamping means for clamping selected areas of the moveable electrode against the spacer layer.

30. The microphone according to any one of the preceding claims, wherein the microphone is omnidirectional.

31. The microphone according to any one of claims 1 to 29, wherein the microphone is directional.

32. The microphone according to claim 31, wherein the microphone includes an acoustic delay element for time-delaying acoustic signals directed to a first face of the moveable electrode with respect to acoustic signals directed to a second opposite face of the moveable electrode.

33. The microphone according to claim 31, in combination with any one of claims 1 to 32, wherein the back plate includes at least one acoustic inlet for introducing acoustic signals into the microphone through the back plate.

34. The microphone according to any one of the preceding claims, wherein acoustic signals are guided into the microphone with a housing.

35. The microphone according to claim 34, wherein the housing is generally cylindrical, and the microphone is disposed within the housing.

36. A stacked microphone formed from a plurality of sub-microphones, each sub-microphone being in accordance with a microphone as claimed in any one of the preceding claims, wherein the sub-microphones are stacked one on top of the other such that all moveable and fixed electrodes are substantially parallel.

37. A method of fabricating components of a capacitive microphone formed from layers, the method including the step of fabricating at least one layer of the microphone using a LIGA process.

38. A method of fabricating components of a capacitive microphone formed from layers comprising a back plate, a diaphragm, and a spacer layer for separating the back plate from the diaphragm, and a clamping layer for clamping the diaphragm against the spacer layer, the method comprising the steps of:
(a) providing a pattern for the layers;
(b) transferring the pattern for each layer onto at least one lithographic mask; and
(c) passing laser light through each lithographic mask such that unmasked light removes unwanted material from each layer.

39. A method of fabricating components of a capacitive microphone formed from layers comprising a back plate, a diaphragm, and a spacer layer for separating the back plate from the diaphragm, and a clamping layer for clamping the diaphragm against the spacer layer, the method comprising the steps of:
providing a pattern for each of the layers;
transferring the pattern onto each layer using a beam of laser light.

40. The method according to claim 39, wherein the step of transferring the pattern involves relative movement of the laser beam with respect to each layer.

41. The method according to claim 39 or claim 40, wherein the step of transferring the pattern comprises directly writing the pattern onto each layer with the laser beam.

42. The method according to any one of claims 38 to 41, wherein the diaphragm and back plate each include an electrically conductive coating which functions as a moveable electrode and fixed electrode, respectively.

43. The method according to any one of claims 38 to 42, wherein each of the layers comprises a layer of a polymer material.

44. The method according to claim 43, wherein the polymer material is polyester.

45. The method according to any one of claims 38 to 44, wherein the laser light has a wavelength of substantially 193 nanometres.
